(19) United States
(12) Patent Application Publication
(10) Pub. No.: US 2010/0079085 A1
(43) Pub. Date: Apr. 1, 2010

(54) SUPPLY CIRCUIT

(75) Inventors: Matthias Wendt, Wuerselen (DE); Heinz Willi Van Der Broeck, Zuelpich (DE); Georg Sauerlaender, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/530,551

(22) PCT Filed: Mar. 10, 2008
(86) PCT No.: PCT/IB08/50862

§ 371 Date: Sep. 9, 2009

(30) Foreign Application Priority Data
Mar. 13, 2007 (EP) 07104061.2

(51) Int. Cl. H05B 41/36

(52) U.S. Cl. 315/294

(57) ABSTRACT

In supply circuits (6) comprising bridge circuits (2) and resonance circuits (3) with primary parts to be coupled to the bridge circuits (2) and secondary parts to be coupled to load circuits (4), the secondary parts are provided with elements (32-34) defining resonance frequencies and resonance impedances, to be able to supply different load circuits (4) and/or different loads (41-42) per load circuit (4) individually. The elements (32-34) may comprise capacitors (34) and inductors (32-33). The resonance frequencies define features of primary signals to be supplied from the bridge circuits (2) to the resonance circuits (3) such as pulse widths of pulses of voltage signals and/or pulse frequencies of the voltage signals. The resonance impedances define features of secondary signals to be supplied from the resonance circuits (3) to the load circuits (4) such as values or average values of current signals.

### FIELD OF THE INVENTION

The invention relates to a supply circuit, and also relates to a device comprising a supply circuit and a load circuit.

Examples of such a supply circuit are switched mode power supplies, without excluding other supply circuits. Examples of such a device are consumer products and non-consumer products. Examples of such a load circuit are one light emitting diode and two or more serial light emitting diodes and two or more parallel light emitting diodes, without excluding other load circuits.

### BACKGROUND OF THE INVENTION

A prior art supply circuit is known from WO 2005/048658, which discloses a resonant power light emitting diode control circuit with brightness and color control. This prior art supply circuit comprises a bridge circuit including a half bridge or a full bridge and comprises a resonance circuit including a transformer. A primary side of the transformer is coupled to the bridge circuit via a capacitor. The capacitor and the primary side of the transformer together form elements defining a resonance frequency (or period) and a resonance impedance. A secondary side of the transformer is coupled to a load circuit.

This prior art supply circuit supplies the load circuit with a load dependent output signal such as a load dependent output current, and requires a feedback loop for controlling the bridge circuit in response to detected light from the load circuit or measured currents flowing through the load circuit.

### SUMMARY OF THE INVENTION

It is an object of the invention, inter alia, to provide a supply circuit capable of supplying different load circuits individually.

It is a further object of the invention, inter alia, to provide a device comprising a supply circuit capable of supplying different load circuits individually.

According to the invention, the supply circuit comprises a bridge circuit and a resonance circuit, the resonance circuit comprising a primary part to be coupled to the bridge circuit and a secondary part to be coupled to a load circuit, the secondary part comprising elements defining a resonance frequency and a resonance impedance.

By locating the elements defining a resonance frequency (or period) and a resonance impedance at a secondary side of the resonance circuit, different load circuits can be supplied individually via one and the same supply circuit by using a first secondary part of the resonance circuit for a first load circuit and by using a second secondary part of the resonance circuit for a second load circuit. This resonant circuit has first and second primary parts coupled to each other in parallel and has first and second secondary parts each coupled to their own load circuits. Alternatively, one and the same primary part may be coupled to two or more secondary parts. As a result, the supply circuit is capable of supplying different load circuits individually. Identical load circuits may be coupled in parallel to one and the same secondary part of the resonance circuit or may be coupled to the bridge circuit via identical or non-identical secondary parts of the resonance circuit. Non-identical load circuits will usually be coupled to the bridge circuit via non-identical secondary parts of the resonance circuit.

The supply circuit according to the invention is further advantageous, inter alia, in that it is capable of supplying different loads in a load circuit individually. In case a load in a load circuit is to be replaced by another different load, the elements in the secondary part of the resonance circuit may need to be replaced by other different elements. Owing to the fact that these elements have been located in the secondary part of the resonance circuit, it may become easier and/or safer to replace such elements.

So, a problem to provide a supply circuit capable of supplying different load circuits individually and/or capable of supplying different loads in a load circuit individually has been solved. Further, the supply circuit supplies each load circuit with a load independent output signal such as a load independent output current, and does not require a feedback loop for controlling the bridge circuit. A switching frequency of the bridge circuit is for example chosen to be not higher than 50% of a resonance frequency of the elements; preferably the switching frequency is exactly 50% of this resonance frequency.

The resonance circuit may comprise an inductor. The entire inductor or a part thereof is coupled to the bridge circuit and the entire inductor or a part thereof is coupled via a series capacitor to the load circuit. In this case, the inductor and the series capacitor form the elements defining a resonance frequency (or period) and a resonance impedance. The primary part comprises the inductor or a part thereof, and the secondary part comprises the inductor or a part thereof and the capacitor.

Alternatively, the resonance circuit may comprise a transformer. A primary side of the transformer is coupled to the bridge circuit and a secondary side of the transformer is coupled via a series capacitor to the load circuit. In this case, the secondary side of the transformer (and/or a leakage inductance of the transformer) and the series capacitor form the elements defining a resonance frequency (or period) and a resonance impedance. The primary part comprises a primary winding, and the secondary part comprises a secondary winding and the capacitor.

An embodiment of the supply circuit according to the invention is defined by the elements comprising a capacitor and an inductor, the resonance frequency defining a feature of a primary signal to be supplied from the bridge circuit to the resonance circuit and the resonance impedance defining a feature of a secondary signal to be supplied from the resonance circuit to the load circuit. The inductor may be a winding of a transformer and/or a leakage inductance of the transformer and/or a real inductor.

An embodiment of the supply circuit according to the invention is defined by the primary signal being a voltage signal and the feature of the primary signal being a pulse width of a pulse of the voltage signal and/or a pulse frequency of the voltage signal, and the secondary signal being a current signal and the feature of the secondary signal being a value of the current signal and/or an average value of the current signal.

An embodiment of the supply circuit according to the invention is defined by the resonance circuit further comprising a further secondary part to be coupled to a further load circuit, the further secondary part comprising further elements defining a further resonance frequency and a further resonance impedance.

An embodiment of the supply circuit according to the invention is defined by the further resonance frequency being substantially equal to the resonance frequency and the further resonance impedance being substantially different from the resonance impedance. Different resonance impedances for example allow different (average) values of current signals to be set for identical load circuits and allow identical (average) values of current signals to be set for different load circuits.

An embodiment of the supply circuit according to the invention is defined by further comprising a switch for dimming a group of light emitting diodes of the load circuit. Such a switch may for example comprise a transistor or a thyristor or a triac and may for example be located in parallel to a load in case of the load receiving a substantially constant current signal and may for example be located serially to a load in case of the load receiving a substantially constant voltage signal.

An embodiment of the supply circuit according to the invention is defined by further comprising a controller for controlling the switch in synchronization with the bridge circuit. By switching the bridge circuit as well as the switch at zero current, electromagnetic interference is minimized.

An embodiment of the supply circuit according to the invention is defined by further comprising a smoothing capacitor for smoothing an input signal for light emitting diodes of the load circuit. The input signal is for example a current signal flowing through a string of light emitting diodes of the load circuit.

An embodiment of the supply circuit according to the invention is defined by further comprising decoupling diodes for decoupling two anti-parallel groups of light emitting diodes of the load circuit from each other.

Embodiments of the device according to the invention correspond with the embodiments of the supply circuit according to the invention.

The invention is based on the insight, inter alia, that different load circuits and/or different loads in a load circuit may need to be supplied individually, and is based on the basic idea, inter alia, that in a resonance circuit the elements defining a resonance frequency and a resonance impedance are to be located relatively close to a load circuit and relatively away from a bridge circuit.

These and other aspects of the invention will be apparent from and elucidated with reference to the embodiments(s) described hereinafter.

### BRIEF DESCRIPTION OF THE DRAWINGS

In the drawings:

FIG. 1 shows diagrammatically a general supply circuit according to the invention comprising a bridge circuit and a resonance circuit,

FIG. 2 shows diagrammatically a first embodiment of the bridge circuit coupled to a source,

FIG. 3 shows a voltage signal generated by the bridge circuit of the FIG. 2,

FIG. 4 shows a voltage signal and a current signal generated by the bridge circuit of the FIG. 2,

FIG. 5 shows diagrammatically a second embodiment of the bridge circuit coupled to a source,

FIG. 6 shows a voltage signal generated by the bridge circuit of the FIG. 5,

FIG. 7 shows a voltage signal and a current signal generated by the bridge circuit of the FIG. 5,

FIG. 8 shows a first embodiment of the supply circuit coupled to a source and to a load,

FIG. 9 shows a second embodiment of the supply circuit coupled to a source and to a load,

FIG. 10 shows a third embodiment of the supply circuit coupled to a source and to a load,

FIG. 11 shows a fourth embodiment of the supply circuit coupled to a source and to a load,

FIG. 12 shows a fifth embodiment of the supply circuit coupled to a source and to a load,

FIG. 13 shows a sixth embodiment of the supply circuit coupled to a source and to a load,

FIG. 14 shows a seventh embodiment of the supply circuit coupled to a source and to a load,

FIG. 15 shows an eighth embodiment of the supply circuit coupled to a source and to a load,

FIG. 16 shows diagrammatically a third embodiment of the bridge circuit coupled to a source,

FIG. 17 shows diagrammatically a fourth embodiment of the bridge circuit coupled to a source,

FIG. 18 shows diagrammatically a first embodiment of the resonance circuit comprising a general diode capacitor network,

FIG. 19 shows diagrammatically a second embodiment of the resonance circuit comprising a specific diode capacitor network for voltage multiplication.

FIG. 20 shows diagrammatically a bridge circuit extended by a capacitive snubber circuit comprising additional capacitors and an inductor, and

FIG. 21 shows the additional current Im generated by the snubber circuit.

### DETAILED DESCRIPTION OF EMBODIMENTS

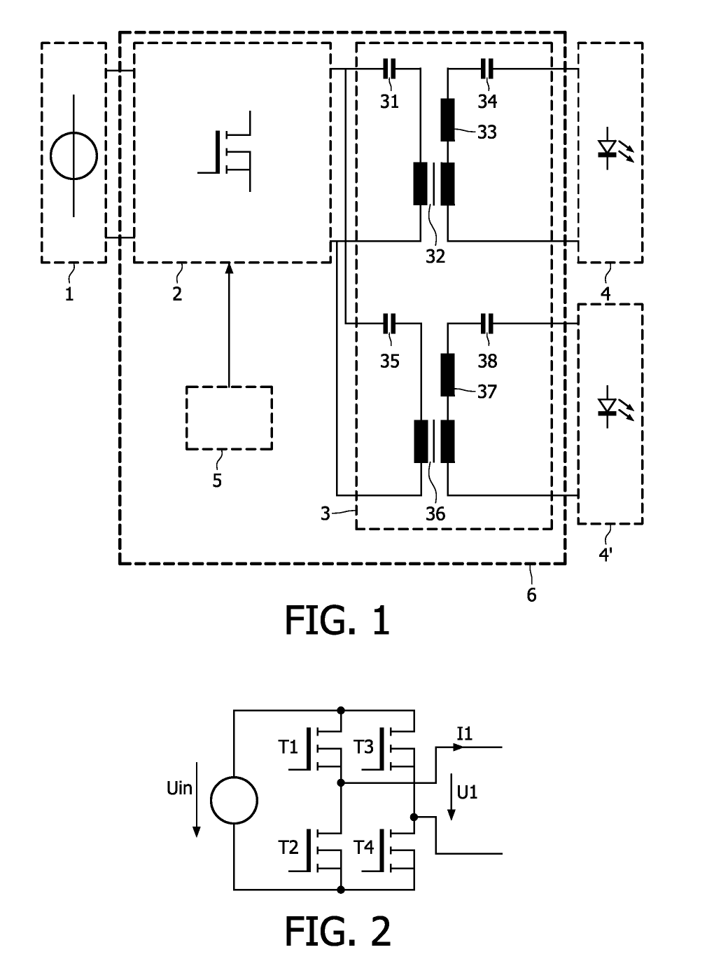

The supply circuit 6 according to the invention shown in FIG. 1 comprises a bridge circuit 2 coupled to a DC source of a source circuit 1 and controlled by a controller 5 and comprises a resonance circuit 3 coupled to the bridge circuit 2 and to load circuits 4 and 4′ each comprising one or more loads. The resonance circuit 3 comprises at least a first primary part comprising a primary winding of a transformer 32 and comprises at least a first secondary part comprising a secondary winding of the transformer 32 coupled serially to a leakage inductance 33 and a capacitor 34. The leakage inductance 33 and the secondary winding may be considered to be one inductor or two inductors. The first secondary part is coupled to a load circuit 4. The resonance circuit 3 may further comprise at least a second primary part comprising a primary winding of a transformer 36 and comprises at least a second secondary part comprising a secondary winding of the transformer 36 coupled serially to a leakage inductance 37 and a capacitor 38. The leakage inductance 37 and the secondary winding may be considered to be one inductor or two inductors. The second secondary part is coupled to a further load circuit 4′. The primary winding of the first transformer 32 is coupled via a coupling capacitor 31 to the bridge circuit 2 and the primary winding of the second transformer 36 is coupled via a coupling capacitor 35 to the bridge circuit 2, alternatively both primary windings may be coupled via one and the same coupling capacitor to the bridge circuit 2. Further alternatively, each transformer may be replaced by an inductor, the inductor or a primary part thereof being coupled to the bridge circuit via a coupling capacitor and the inductor or a secondary part thereof being coupled to its load circuit via a capacitor that together with (the secondary part of) the inductor defines the resonance frequency and the resonance impedance.

FIG. 2 shows diagrammatically a first embodiment (full bridge) of the bridge circuit 2 coupled to a DC source Uin.

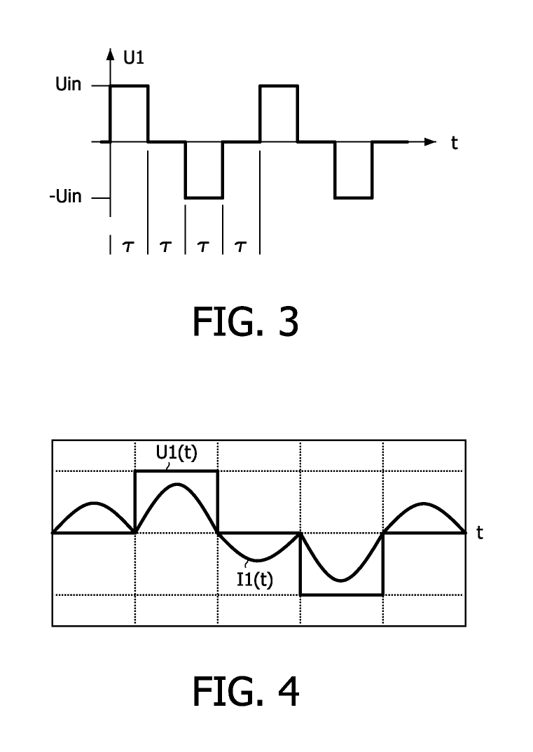

FIG. 3 shows a voltage signal U1(t) generated by the bridge circuit 2 of the FIG. 2 and supplied to the resonance circuit 3, this voltage signal U1(t) comprises a positive pulse having an amplitude Uin, followed by a zero pulse, followed by a negative pulse having an amplitude Uin, and followed by another zero pulse, each pulse having a duration tau, the voltage signal U1(t) having a period 4tau.

FIG. 4 shows a voltage signal U1(t) and a current signal I1(t) generated by the bridge circuit 2 of the FIG. 2 and supplied to the resonance circuit 3.

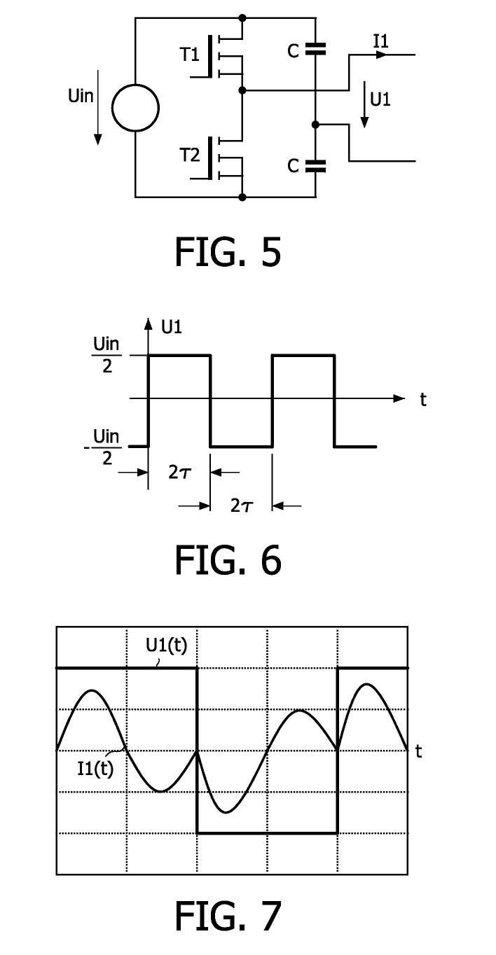

FIG. 5 shows diagrammatically a second embodiment of the bridge circuit (half bridge) coupled to a DC source Uin.

FIG. 6 shows a voltage signal U1(t) generated by the bridge circuit of the FIG. 5 and supplied to the resonance circuit 3, this voltage signal U1(t) comprises a positive pulse having an amplitude Uin/2, followed by a negative pulse having an amplitude Uin/2, each pulse having a duration 2tau, the voltage signal U1(t) having a period 4tau.

FIG. 7 shows a voltage signal U1(t) and a current signal I1(t) generated by the bridge circuit 2 of the FIG. 5 and supplied to the resonance circuit 3.

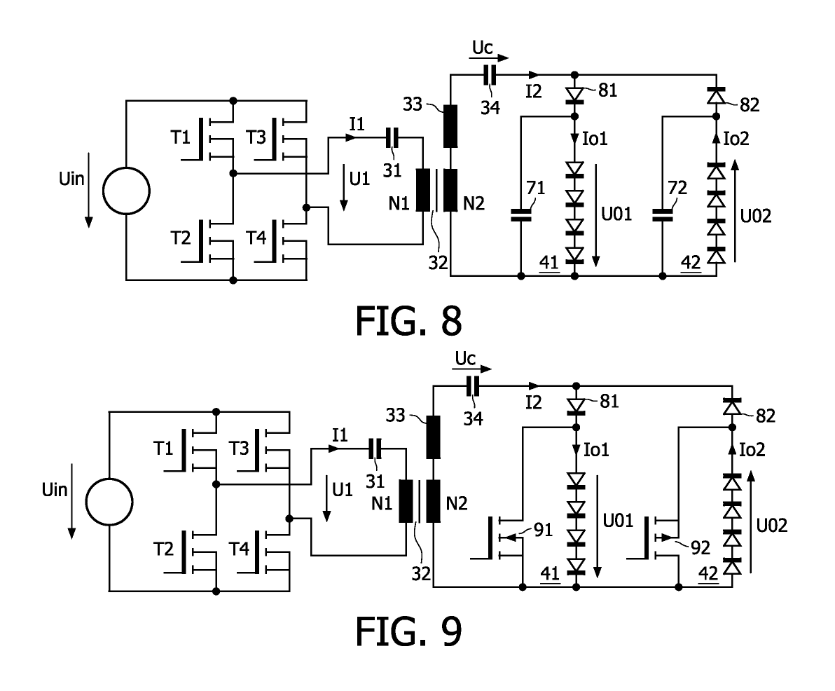

FIG. 8 shows a first embodiment of the supply circuit coupled to a source and to a load. This supply circuit comprises a bridge circuit based on a full bridge and a resonance circuit based on a transformer 32 having a primary winding N1 and a secondary winding N2. This secondary winding N2 is serially coupled via a leakage inductance 33 and a capacitor 34 to two anti-parallel branches. A first branch comprises a first decoupling diode 81 coupled to a first string of light emitting diodes 41, the first string being coupled in parallel to a first smoothing capacitor 71. A second branch comprises a second decoupling diode 82 coupled to a second string of light emitting diodes 42, the second string being coupled in parallel to a second smoothing capacitor 72. Each one of the units 71-72 and 81-82 may form part of the resonance circuit 3 or of the load circuit 4. The smoothing capacitors 71 and 72 may also be removed. In this case the current in the LEDs becomes pulsating but its average value remains unaffected.

FIG. 9 shows a second embodiment of the supply circuit coupled to a source and to a load. This supply circuit differs from the one shown in the FIG. 8 in that the smoothing capacitors 71-72 have been replaced by switches 91-92 in the form of transistors for dimming the strings. Thereto, the switches 91-92 are to be switched on and off, preferably in synchronization with the bridge circuit to minimize electromagnetic interference. In the latter case, the controller 5 may be used for controlling these switches 91-92 as well. A duty cycle of the switching of the switches determines a dimming factor.

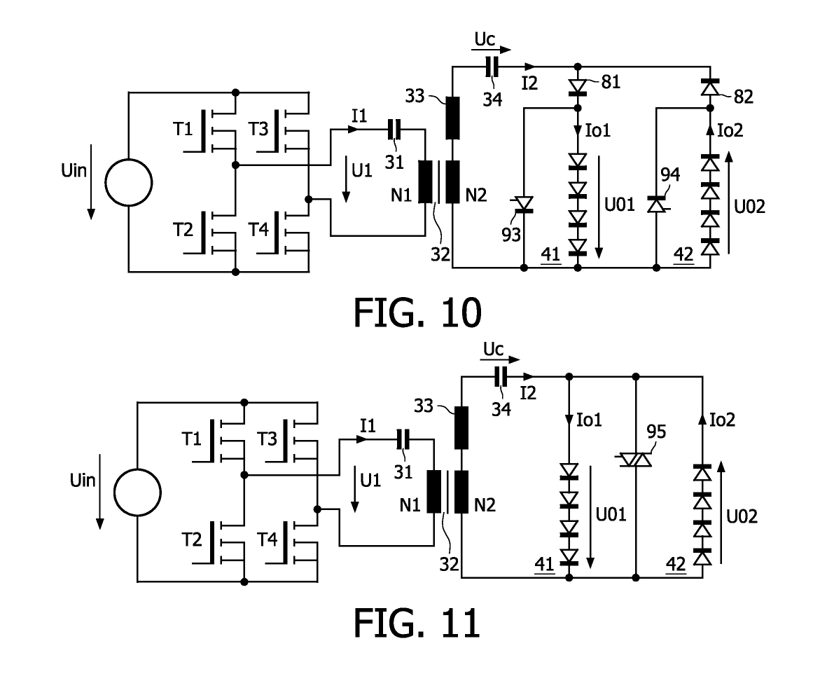

FIG. 10 shows a third embodiment of the supply circuit coupled to a source and to a load. This supply circuit differs from the one shown in the FIG. 9 in that the switches 93-94 are in the form of thyristors for dimming the strings.

FIG. 11 shows a fourth embodiment of the supply circuit coupled to a source and to a load. This supply circuit differs from the one shown in the FIGS. 9 and 10 in that the decoupling diodes have been removed and in that both switches have been replaced by one switch 95 in the form of a triac for dimming both strings.

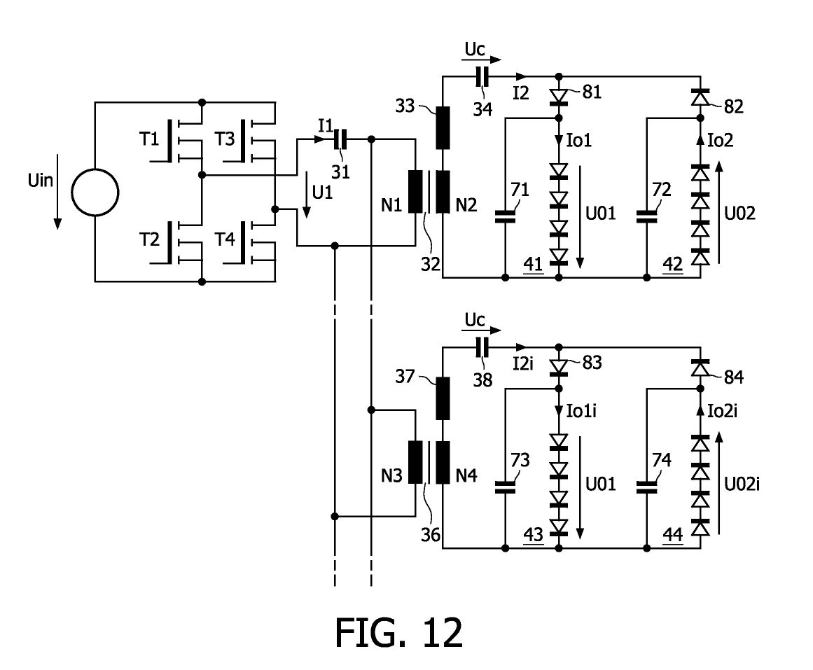

FIG. 12 shows a fifth embodiment of the supply circuit coupled to a source and to a load. This supply circuit has a resonance circuit comprising two transformers 32 and 36. The transformer 32 and its following circuitry has been discussed before. The transformer 36 has a primary winding N3 and a secondary winding

N4. This secondary winding N4 is serially coupled via a leakage inductance 37 and a capacitor 38 to two anti-parallel branches. A third branch comprises a third decoupling diode 83 coupled to a third string of light emitting diodes 43, the third string being coupled in parallel to a third smoothing capacitor 73. A fourth branch comprises a fourth decoupling diode 84 coupled to a fourth string of light emitting diodes 44, the fourth string being coupled in parallel to a fourth smoothing capacitor 74. Each one of the units 73-74 and 83-84 may form part of the resonance circuit 3 or of the further load circuit 4′. N1 and N3 may be equal or different and N2 and N4 may be equal or different.

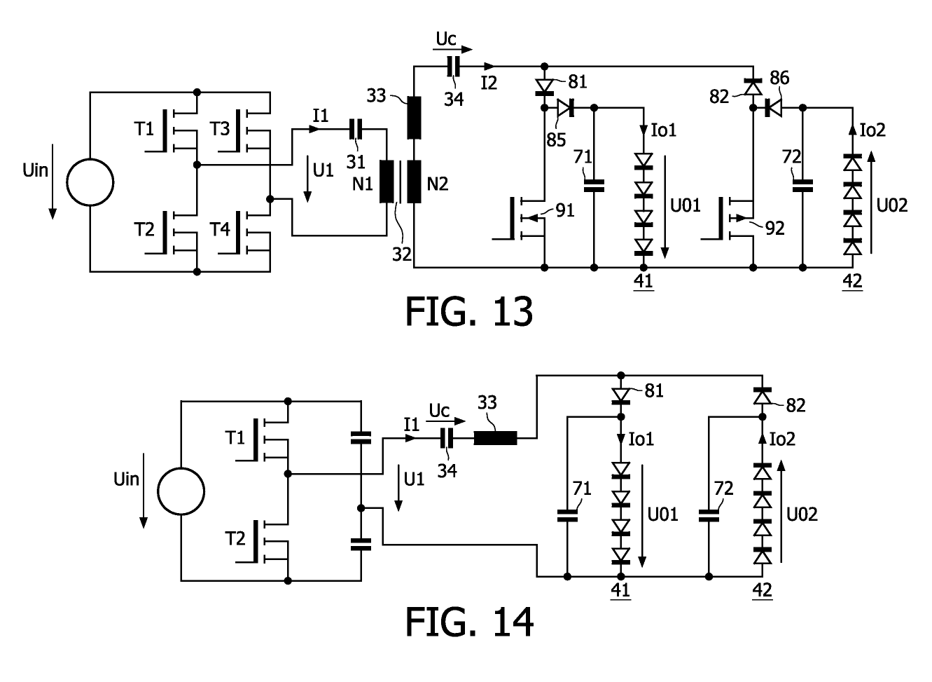

FIG. 13 shows a sixth embodiment of the supply circuit coupled to a source and to a load. In this case, the first branch comprises the first decoupling diode 81 coupled to a parallel circuit of the first switch 91 and circuitry 41,71,85. The circuitry 41,71,85 comprises a serial circuit of a further first decoupling diode 85 and a parallel circuit comprising the first smoothing capacitor 71 and the first string 41 all already discussed before. The second branch comprises the second decoupling diode 82 coupled to a parallel circuit of the second switch 92 and circuitry 42,72,86. The circuitry 42,72,86 comprises a serial circuit of a further second decoupling diode 86 and a parallel circuit comprising the second smoothing capacitor 72 and the second string 42 all already discussed before.

FIG. 14 shows a seventh embodiment of the supply circuit coupled to a source and to a load. This supply circuit comprises a bridge circuit based on a half bridge and a resonance circuit based on a series circuit of a capacitor 34 and an inductor 33 coupled to circuitry 41-42,71-72,81-82 all discussed before.

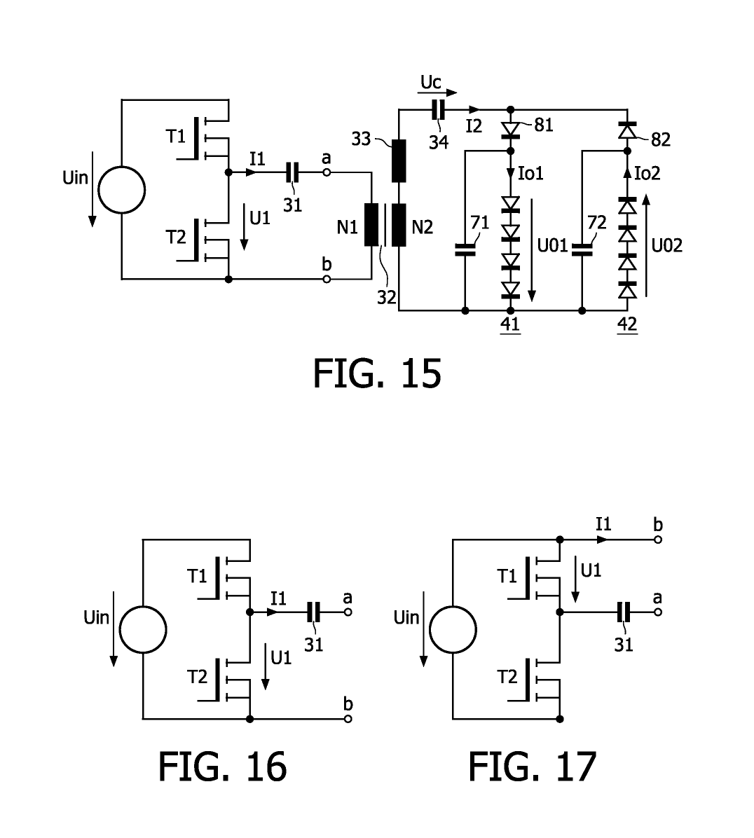

FIG. 15 shows an eighth embodiment of the supply circuit coupled to a source and to a load. This supply circuit comprises a bridge circuit based on a half bridge and a resonance circuit in line with the one shown in the FIG. 8.

FIG. 16 shows diagrammatically a third embodiment of the bridge circuit (half bridge) coupled to a DC source Uin.

FIG. 17 shows diagrammatically a fourth embodiment of the bridge circuit (half bridge)-coupled to a DC source Uin.

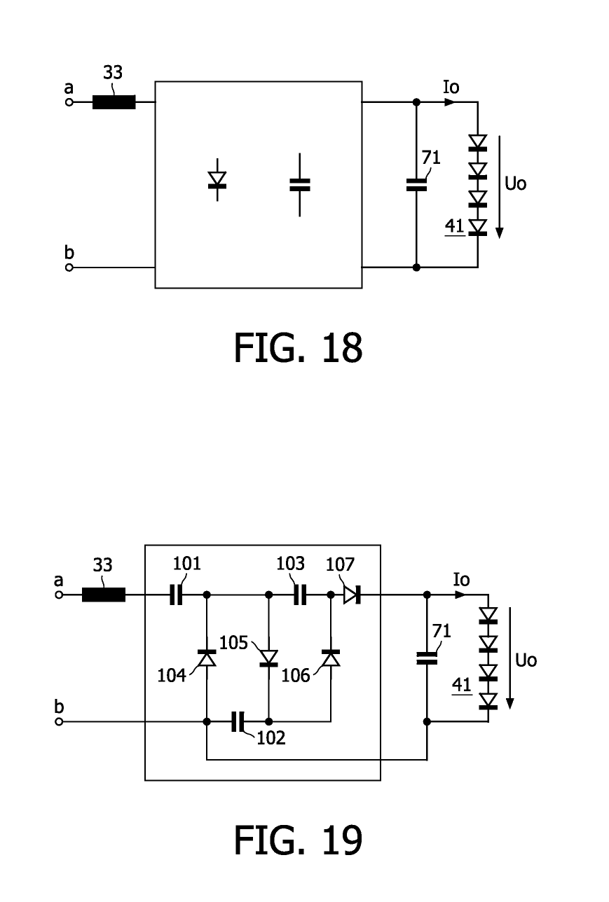

FIG. 18 shows diagrammatically a first embodiment of the resonance circuit comprising a general diode capacitor network coupled in parallel to a smoothing capacitor 71 and a string 41. The general diode capacitor network is further coupled serially via an inductor 33 to a bridge circuit not shown here and realizes a capacitance that together with the inductor 33 forms the elements defining a resonance frequency and a resonance impedance.

FIG. 19 shows diagrammatically a second embodiment of the resonance circuit comprising a specific diode capacitor network for voltage multiplication. The specific diode capacitor network comprises a capacitor 101 of which one side is coupled to the inductor 33 and of which the other side is coupled to one side of a capacitor 103 and to one side of diodes 104 and 105. The other side of the diode 104 is coupled to one side of a capacitor 102 and to one side of the parallel circuit of the smoothing capacitor 71 and the string 41. The other side of the capacitor 103 is coupled to one side of diodes 106 and 107. The other side of the diode 107 is coupled to the other side of side of the parallel circuit of the smoothing capacitor 71 and the string 41. The other side of the capacitor 102 is coupled to the other side of the diodes 105 and 106. This diode capacitor network has a voltage multiplying function and realizes a capacitance that together with the inductor 33 forms the elements defining a resonance frequency and a resonance impedance.

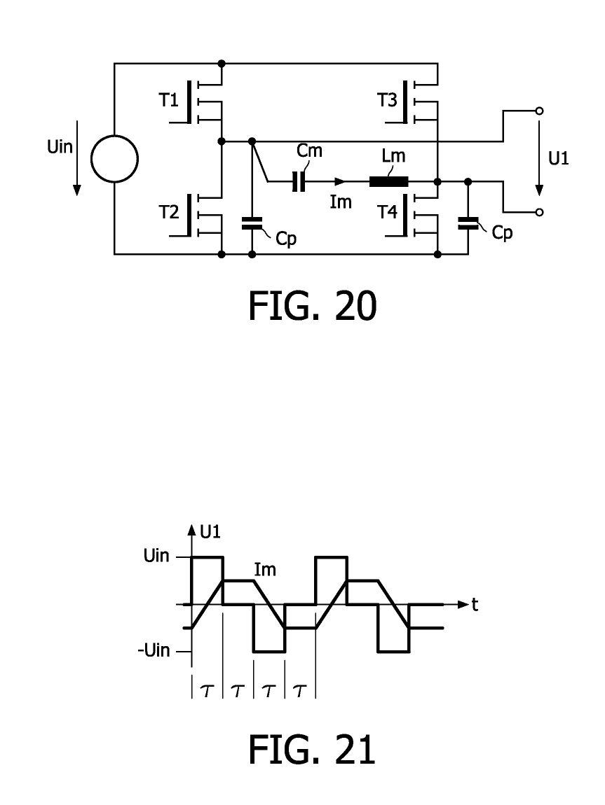

FIG. 20 shows diagrammatically another embodiment of the bridge circuit 2 comprising a snubber network to provide zero voltage switching. This snubber network consists of capacitors Cp connected in parallel to each half-bridge and a series connection of an inductor Lm and a capacitor Cm connected to the output terminals of the bridge circuit. The capacitor Cm shows a large capacitance and it is only applied to prevent a DC current in the inductor Lm.

As shown in the FIG. 21 the supply voltage U1 generates a certain current Im in the inductor. This current is used to perform zero voltage switching in the snubber capacitors Cp of the half-bridges. It requires all transistors to be in the off-state for a short time during switching. This dead time has at least to cover the commutation time of the transistor voltage from Uin to zero or vice versa. The snubber capacitors may also be connected to the upper transistors of the bridge or the parasitic capacitances of the transistors may be used as snubber capacitors.

In other words, the invention may concern a novel galvanic isolating, resonant operating driver topology for independent current control in multiple light emitting diode or LED strings. This driver topology may be supplied by a substantially stabilized DC voltage, generated by for example a pre-conditioner circuit from the AC line. The invented resonant driver topology may consist of one main transistor H-bridge or of one main transistor half-bridge and multiple LED loads. The resonant topology may be formed by a stray inductance of a transformer and a series capacitor on a secondary side. The H-bridge may be switched by a fixed frequency and duty cycle, which generates alternately positive and negative voltage pulses and zero voltage states in between. All voltage states may show the same pulse width, which may be equal to half the resonant period.

In case of a transistor half-bridge a 50% duty cycle may be set and the switching frequency may be half the resonant frequency.

For dimming purposes, additional transistors can be inserted to bypass single LED strings. The basic topology and control scheme is presented in FIGS. 8 and 14. It can be operated with and without the smoothing capacitors. FIG. 9 shows an extended version of the driver for providing independent LED current control.

The bridge supply circuit can also be operated in zero voltage-switching mode by adding a capacitive snubber circuit as shown in the FIGS. 20 and 21.

The invented resonant LED driver circuit provides the following features:
The LED driver provides galvanic isolation by means of a transformer and allows voltage adapting by the transformer turns ratio.
The parasitic leakage inductance of the transformer is involved in the circuit operation and it is thus part of the driver.
The leakage inductance does not need to be minimized. This is of advantage for the isolation and winding design and it thus keeps the costs low.
The currents in the converter always flow sinusoidally and the transistors of the converter are only switched at zero current. This holds for all transistors of the main H-bridge or of the half-bridge as well as for transistors, which may be connected in parallel to the LED strings for individual dimming purposes. As an advantage the EMI contribution of the driver circuit can be kept very low.
The EMI behavior can be further improved by adding a capacitive snubber circuit to the supplying bridge or half bridge to perform zero voltage switching.
The average current in the LED load is automatically stabilized and determined by the input voltage Uin and the resonant impedance Zres.
The average currents of both LED strings are independent of the number of LEDs connected in series including a short circuit output. Thus, all outputs are short circuit proved.
The average currents in both LED loads also remain constant in case of asymmetrical load voltages (different number of LEDs connected in series). This also includes a single short output.
In case of asymmetrical output load voltages the series capacitor of the secondary side automatically prevents a DC offset at the transformer.
If the LED averaged load voltage is higher than the transformed input voltage, no current flows. Hence, the converter is no load proved.
The LED currents can be smoothed to pure DC by additional capacitors without influencing the average LED current.
The LED driver system does not require a current sensor.
The power and control unit of the main H-bridge or the half-bridge can be integrated in a smart power IC.
The LED currents can be controlled by using bypassing transistors (FIG. 9). This allows independent dimming functions for both outputs.
In addition, common dimming for both output currents may be achieved by decreasing the switching frequency.
One basic H-bridge or one basic half-bridge can be used to supply multiple transformer-resonant-LED loads.

A main power part consists of one H-bridge realized by 4 transistors (T1,T2,T3,T4). These transistors can be MOSFETs but also any other semiconductor switches. The transistors may be operated by a fixed control scheme, which alternately generates at the H-bridge output a positive and negative voltage pulse and zero voltage states between the pulses. All voltages states should occur for the same time duration. The resulting output voltage of the H-bridge U1(t) is shown in FIG. 3. The H-bridge supplies a transformer, which is characterized by the number of turns on the primary side N1, the number of turns on the secondary side N2 and the leakage inductance. The leakage inductance of the transformer can either be assigned to the primary or to the secondary side. For the invention the leakage inductance should be assigned to the secondary side. A series capacitor on the primary side is used to prevent a DC offset at the transformer. Since the output voltage of the H-bridge has no principle offset the voltage at this series capacitor may be very low. An offset at the transformer may also be prevented by any adapted control scheme for the main H-bridge (T1,T2,T3,T4). The leakage inductance of the transformer and the series capacitor on the secondary side form a resonant circuit characterized by the resonant frequency

$${f}_{RES} = \frac{1}{2 \cdot π \cdot \sqrt{Ls \cdot Cs}} = \frac{1}{{T}_{RES}}$$

and by the resonant impedance

$${Z}_{RES} = \sqrt{\frac{Ls}{Cs}} .$$

One transformer can be used to supply two LED strings LED1 and LED2, which are decoupled by the decoupling diodes D1 and D2. In order to smooth the current in the LED strings, the smoothing capacitors can be added.

The pulse time of the H-bridge output voltage should be equal to half the resonant period τ=T_{RES}/2. Thus, the switching frequency of the H-bridge is half the resonant frequency fs=fres/2.

If the conditions are fulfilled, two successive sinusoidal half-wave current pulses are drawn from the H-bridge for each voltage pulse. Neglecting the magnetization current, the secondary current of the transformer is proportional to the primary current

$$I 2 = I 1 \cdot \frac{N 1}{N 2} .$$

The characteristic secondary transformer current I1(t) is presented in FIG. 4 for a certain operation point. It is split in a positive and a negative part by the diodes decoupling diodes. The positive current is flowing in the LED string 41 while the negative part flows in the LED string 42.

Under the given conditions the average current in both LED strings is constant. It can be set by the input voltage Uin, the resonant impedance Zres and by the winding turn ratio of the transformer:

$${\overline{I}}_{01} = {\overline{I}}_{02} = \frac{Uin}{{Z}_{RES}} \cdot \frac{1}{π} \cdot \frac{N 2}{N 1}$$

The average current in the LEDs is not influenced by the voltage drop of the LEDs. It is thus possible to supply an arbitrary number of LEDs.

The average output current remains constant for any asymmetrical load voltage distribution given by

$$0 \leq \frac{{U}_{01} + {U}_{02}}{2} \leq \frac{N 2}{N 1} \cdot Uin$$

If the number of LEDs leads to a corresponding voltage drop higher than the given upper limit

$$\frac{{U}_{01} + {U}_{02}}{2} > \frac{N 2}{N 1} \cdot Uin ,$$

no current flows. The LED driver is thus short circuit proved and no load proved.

The converter can also be operated without the smoothing capacitors. In this case the positive part of the current I1(t) is identical to the LED current Io1 while the negative part is identical to the LED current Io2. As an important feature the averaged current is not affected by the smoothing capacitors. During the pulses the amplitude of the current sinewave of I1(t) can be described by the equation

$${\hat{I}}_{1} = \frac{Uo 1 + Uo 2}{2 \cdot {Z}_{RES}}$$

while the amplitude during the free wheel state can be described by the equation

$${\hat{I}}_{1} = ( Uin \cdot \frac{N 2}{N 1} - \frac{Uo 1 + Uo 2}{2} ) \cdot \frac{1}{Zres}$$

The FIG. 4 shows the resulting current I1(t) for

$$Uo 1 = \frac{N 2}{N 1} \cdot Uin \cdot \frac{3}{4} and Uo 2 = \frac{N 2}{N 1} \cdot Uin \cdot \frac{1}{2}$$

Since the average current is independent of the load voltage including a short output, the converter can be extended to perform independent dimming functions.

This is presented in FIG. 9, where instead of the smoothing capacitors the transistors are inserted. If these transistors are in the on-state the current I1(t) is bypassed so that the current in the LED string becomes zero. By turning on and off these transistors repetitively, the average current in the corresponding LED string can be controlled between a nominal value and zero.

The on- and off-time instances of the transistors may be set by any control scheme. It is however favorable if these times are synchronized with the frequency of the H-bridge. In this case the control signals can be derived from the secondary voltage of the transformer and switching only occurs at zero current. The limited resolution of the LED current—determined by the switching period T=2·τ—can usually be tolerated.

As shown in FIG. 10 the dimming function may also be realized by two fast thyristors.

Another alternative component to control the LED currents is a fast triac, which performs the dimming function for both LED strings (see FIG. 11).

The dimming function can also be applied to the LED load with smoothing capacitors. In this case two additional decoupling diodes may be required as illustrated in FIG. 13.

The LED string modules presented before may be multiple connected to one H-bridge. This is shown in FIG. 12. Each module has its own transformer. The resonant elements are formed individually by the capacitance and the leakage inductance. Different output currents can be chosen by varying the turn ratio of the transformer. Moreover, it is also possible to change the averaged output current by varying the properties of the resonant inductance and the capacitance for a fixed resonance frequency. The LED transformer module may employ a smoothing capacitor or transistors or thyristors for individual dimming operation.

Possible modifications of the invention are:
On the secondary side of the resonance circuit, a full-bridge rectifier may be used to supply one LED string.
The driver can be supplied by any other stabilized DC voltage.
The driver may be realized without transformer but a series choke for forming the resonant topology.
Each LED could be dimmed individually by a bypassing switch.
Another possible modification is the use of a transistor half-bridge instead of a transistor H-bridge. This is illustrated in FIGS. 16 and 17. In case of a half-bridge two out of four transistors T3 and T4 may be replaced by capacitors, which provide a voltage divider. In order to achieve a similar behavior for the LED load, the half-bridge may be controlled by a fixed duty cycle of for example 50% and a fixed switching frequency equal to for example half the resonant frequency fs=f_{RES}/2. The resulting voltage U1(t) is shown in FIG. 6.

The half-bridge topology can be used to supply the same load as the H-bridge including all transformer and dimming options.

As one example FIG. 14 presents the direct supply of two decoupled LED loads showing the voltage drop Uo1 and Uo2. The series resonance is formed in the same way as in case of a H-bridge:

$${f}_{RES} = \frac{1}{2 \cdot π \cdot \sqrt{Ls \cdot Cs}} = \frac{1}{{T}_{RES}}$$

$${Z}_{RES} = \sqrt{\frac{Ls}{Cs}}$$

Under these conditions two successive sinusoidal half-wave currents are drawn from the half-bridge in each half period. This is shown in the diagram of FIG. 7 which has been derived for Uo1=Uin/4 and Uo2=0.

The first half-wave is drawn from the input voltage. Its amplitude can be determined by using the equation:

$${\hat{I}}_{1} = ( Uin \cdot \frac{1}{2} + \frac{Uo 1 + Uo 2}{2} ) \cdot \frac{1}{Zres}$$

The second current half-wave is fed back to input voltage source. Its amplitude is given by

$${\hat{I}}_{2} = ( Uin \cdot \frac{1}{2} - \frac{Uo 1 + Uo 2}{2} ) \cdot \frac{1}{Zres}$$

Both current half-waves are also feeding the LED load.

This leads to an average output current in both LED loads which is independent of the voltage drop

$${\overline{I}}_{01} = {\overline{I}}_{02} = \frac{Uin}{{Z}_{RES}} \cdot \frac{1}{π} \cdot \frac{1}{2}$$

Note that any asymmetrical load can be supplied including a short circuit in one or both outputs. This behavior of the circuit occurs for load voltages

0≦U₀₁+U₀₂≦·Uin

For higher output voltage drops no current flows.

Another possible configuration of the half-bridge is presented in FIGS. 16 and 17.

In these power drivers the capacitive voltage divider is omitted. The corresponding voltage offset of U1(t) has to be taken over by the series capacitor. The resulting resonant current I1(t) and the load currents are the same as in case of a driver with capacitive voltage divider.

Another possible modification of the LED driver can be seen in the extension of the resonant circuit by more diodes and capacitors. Based on the output terminals (a,b) of the full- and half-bridge configurations presented, a series inductor and a diode-capacitor network may be inserted to feed the LED load. This is illustrated in FIG. 18. The diode capacitor network behaves like a voltage multiplier circuit allowing load voltage higher than the input DC voltage. FIG. 19 shows one example of a resonant driver extended by a diode capacitor network. Note that the capacitors of the diode capacitor network may influence the resonant frequency of the circuit. This can be adapted by the inductance of the series inductor. Similar to earlier explanation the smoothing capacitor connected in parallel to the LED load may be removed without influencing the average load current.

Potential applications are for example wall flooding, LCD backlighting and general illumination.

Summarizing, in supply circuits 6 comprising bridge circuits 2 and resonance circuits 3 with primary parts to be coupled to the bridge circuits 2 and secondary parts to be coupled to load circuits 4, the secondary parts are provided with elements 32-34 defining resonance frequencies and resonance impedances, to be able to supply different load circuits 4 and/or different loads 41-42 per load circuit 4 individually. The elements 32-34 may comprise capacitors 34 and inductors 32-33. The resonance frequencies define features of primary signals to be supplied from the bridge circuits 2 to the resonance circuits 3 such as pulse widths of pulses of voltage signals and/or pulse frequencies of the voltage signals. The resonance impedances define features of secondary signals to be supplied from the resonance circuits 3 to the load circuits 4 such as values or average values of current signals.

A term “substantially equal” defines maximum deviations <30%, preferably <20%, further preferably <10%, most preferably <1%. In other words, such a term defines intervals of 70-130%, preferably 80-120%, further preferably 90-110%, most preferably 99-101%. A term “substantially different” defines minimum deviations of >1%, preferably >10%, further preferably >20%, most preferably >30%. In other words, such a term defines intervals of <99% and >101%, preferably <90% and >110%, further preferably <80% and >120%, most preferably <70% and >130%.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. Supply circuit comprising:
a bridge circuit,
a resonance circuit comprising a first transformer and
a first load circuit comprising at least one light emitting diode,
wherein the first transformer comprises a primary part connectable to the bridge circuit and a secondary part connectable to the first load circuit, the primary part comprising a primary winding of the first transformer and the secondary part comprising a secondary winding of the first transformer and a plurality of elements defining a first resonance frequency and a first resonance impedance.

2. Supply circuit of claim 1, wherein the plurality of elements a capacitor and an inductor comprising the secondary winding and/or a leakage inductance of the first transformer, the first resonance frequency defining a feature of a primary signal to be supplied from the bridge circuit to the resonance circuit and the first resonance impedance defining a feature of a secondary signal to be supplied from the resonance circuit to the load circuit.

3. Supply circuit claim 2, wherein the primary signal is a voltage signal and the feature of the primary signal is a pulse width of a pulse of the voltage signal and/or a pulse frequency of the voltage signal, and wherein the secondary signal is a current signal and the feature of the secondary signal is a value of the current signal and/or an average value of the current signal.

4. Supply circuit of claim 1, the resonance circuit further comprising a second transformer having a primary part connectable to the bridge circuit and a secondary part connectable to a second load circuit, the primary part comprising a primary winding of the second transformer, the further secondary part comprising a secondary winding of the second transformer and further elements (37-38) defining a second resonance frequency and a second resonance impedance.

5. Supply circuit of claim 4, the second resonance frequency being substantially equal to the first resonance frequency and the second resonance impedance being substantially different from the second resonance impedance.

6. Supply circuit of claim 1, further comprising a switch for dimming the light emitting diodes.

7. Supply circuit of claim 6, further comprising a controller for controlling the switch in synchronization with the bridge circuit.

8. Supply circuit of claim 1, further comprising a smoothing capacitor for smoothing an input signal for the light emitting diodes.

9. Supply circuit of claim 1, wherein the first load circuit comprises two anti-parallel groups of light emitting diodes, the supply circuit further comprising decoupling diodes for decoupling the two anti-parallel groups of light emitting diodes from each other.

10. (canceled)
